(19) United States
(12) Patent Application Publication
(10) Pub. No.: US 2008/0297864 A1
(43) Pub. Date: Dec. 4, 2008

(54) Use of Holographic Sensor to Determine Sterilisation

(76) Inventors: Adrian Horgan, Cambridge (GB); Alexander James Marshall, Cambridge (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/996,182

(22) PCT Filed: Jul. 18, 2006
(86) PCT No.: PCT/GB2006/002675

§ 371 Date: May 21, 2008

(30) Foreign Application Priority Data
Jul. 18, 2005 (GB) 0514700.4

(51) Int. Cl. G03H 1/00

(52) U.S. Cl. 359/1

(57) ABSTRACT

In a method of determining the effectiveness of a sterilization procedure using a biological indicator, the biological indicator comprises a holographic sensor and spores or an enzyme. The method and the biological indicator rely on the holographic sensor to indicate the effectiveness of me sterilisation procedure and do not require a conventional pH indicator, a fluorophore or chromophore.

### FIELD OF THE INVENTION

The present invention relates to a method of determining the effectiveness of a sterilisation procedure using a biological indicator and to a biological indicator for use in such a method.

### BACKGROUND TO THE INVENTION

Biological indicators are used in the infection control industry to monitor the effectiveness of sterilization procedures using liquid, steam or gas plasma sterilants. The biological indicators are included with every load of articles to be sterilized and act as quality control devices to confirm the antimicrobial effectiveness of the sterilization procedure.

Biological indicators can be grouped into conventional biological indicators, rapid readout biological indicators and dual rapid readout biological indicators. With each of these types, the failure of a sterilization procedure is indicated by a detectable change in the biological specimen which is either an enzyme, a microorganism, or both.

Traditional biological indicators provide an accurate and direct method of determining the effectiveness of a sterilization procedure by measuring the effect on a test population of microorganisms included in the indicator. If a sterilization procedure fails to generate a condition that is lethal to the test microorganisms, surviving cells are detected following a period of incubation and growth. The test microorganism is typically a microorganism which is several times more resistant to the sterilization process being monitored than the microorganisms that might be present due to natural contamination. Spores such as those of Bacillus subtilis can be used due to their hardy resistance.

Conventional biological indicators usually consist of an ampule containing growth medium and a pH indicator dye that is enclosed within a second outer vessel that contains a spore strip. During sterilization, the spores are exposed to sterilant but the growth medium and indicator are untouched. Following sterilization, the ampule containing the enclosed growth medium is broken open so that it can contact the spores. If any test spores have survived the sterilization process, their presence may be subsequently detected from the change in the pH of the growth medium and the accompanying change in the colour of the pH indicator dye.

Although this type of biological indicator is accurate and is self-contained (does not need to be opened at any point during the test procedure), the indicators are slow and require up to seven days for a result. The delay between sterilization and obtaining a confirmatory result means that, in practice, equipment is often used without waiting. Negative biological indicator results are then used later to identify and remedy existing sterility problems, rather than prevent them from occurring in the first instance.

More rapid results may be obtained using so-called “Rapid Readout” biological indicators. In this case, an enzyme is used in place of spores. Usually, the enzyme is derived from the spores and its activity post-sterilization has been correlated with the spore's survival. After exposure of the enzyme to the sterilant, an ampoule containing a fluorogenic or chromogenic enzyme substrate is broken and the resulting enzyme-modified product, if viable enzyme is still present, is detected from a change in colour or luminescence.

In so-called “Dual Rapid Readout” indicators, both the traditional and enzyme methods are combined so that a rapid, three-hour result is possible, which can be later confirmed by a spore outgrowth test. US 2002/0115131 is concerned with rapid readout sterilization where the enzyme is contained within a pellet within an insoluble gel matrix, to prevent the tendency of liquid sterilants to wash away the enzyme.

Holographic sensors are known. In particular, they are described in WO95/26499 and WO99/63400. Such sensors comprise a support medium having a hologram disposed therein or thereon, and are responsive to the presence of an analyte which affects the medium and thereby causes a change in an optical characteristic of the sensor.

### SUMMARY OF THE INVENTION

According to a first aspect of the present invention, in a method of determining the effectiveness of a sterilization procedure using a biological indicator, the biological indicator comprises a holographic sensor and spores, where the holographic sensor comprises a support medium having a hologram disposed therein or thereon, and the method involves the steps of:
a. contacting the spores with a sterilizing agent; then
b. contacting the spores with a growth medium and allowing any surviving spores to grow wherein spore growth causes variation of a physical property of the support medium and that variation causes a change in the optical characteristics of the holographic sensor; and
c. observing an optical property of the holographic sensor, to detect changes resulting from spore growth.

According to a second aspect of the present invention, in a method of determining the effectiveness of a sterilization procedure using a biological indicator, the biological indicator comprising a holographic sensor and an enzyme where the holographic sensor comprises a support medium having a hologram disposed therein or thereon,

where the activity of the enzyme is correlated with the survival of a test microorganism,

the activity of the enzyme determines the degree of interaction between the enzyme and the support medium, and

interaction of the enzyme with the support medium causes variation of a physical property of the support medium and that variation causes a change in the optical characteristics of the holographic sensor,

the method involves the steps of:
a. contacting the enzyme with a sterilizing agent; and
b. observing an optical property of the holographic sensor to detect changes resulting from a change in the activity of the enzyme.

According to a third aspect of the present invention, a biological indicator suitable for use in a method as described above comprises a holographic sensor wherein the holographic sensor comprises a support medium having a hologram disposed therein or thereon and spores or an enzyme.

The method and biological indicator of the present invention rely on the holographic sensor to indicate the effectiveness of the sterilisation procedure and does not require a conventional pH indicator, a fluorophore or chromophore. The optical properties of the holographic sensor can be read with the naked eye or with an optical reader. Using a holographic sensor to determine the effectiveness of a sterilisation procedure can provide increased accuracy and more rapid results than known indicators.

### BRIEF DESCRIPTION OF THE DRAWINGS

FIG. 1 is a cross section of a biological indicator according to an embodiment of the present invention;

FIG. 2 is a cross section of a biological indicator according to a different embodiment of the present invention.

### DESCRIPTION OF THE INVENTION

Holographic sensors are very versatile and can be designed to be sensitive to a variety of conditions. For example, an enzyme can be included in the holographic sensor, the activity of which is correlated with the survival of a test microorganism. In this case, the holographic sensor may comprise a medium which interacts with the enzyme, where the degree of interaction varies with the activity of the enzyme.

In a preferred embodiment, the sensor includes a spore of a microorganism. In this embodiment, growth medium is provided so that it can be contacted with the holographic sensor after contact with the sterilising agent to cause growth of any surviving spores. The holographic sensor can be designed to be sensitive to spore metabolites used as biomarkers (such as H⁺, DPA). As the spores are embedded in the sensor itself, the biological indicator exhibits increased sensitivity and a rapid response time. Alternatively, the physical changes alone, such as swelling, caused by growth of the spores may lead to interaction with the support medium to cause a detectable change in optical properties of the holographic sensor.

Alternatively, a pH-sensitive hologram may be used, which relies on the same mechanism as a conventional pH biological sensor, but is capable of achieving faster results.

The optical changes in the holographic sensor observed in the present invention can be a change in the hologram image which may be wording. Hence, sophisticated indications of sterilisation success or failure can be employed, such as a tick to indicate successful sterilisation. Alternatively, words such as “safe”, “sterile” or “contaminated” could appear.

The method of the present invention makes use of a biological indicator comprising a holographic sensor. Holographic sensors comprise a support medium having a hologram disposed therein or thereon. The support medium is preferably a hydrogel matrix. Such sensors are generally described in WO95/26499, WO99/64300 and WO03/087899, the contents of which are incorporated herein by reference.

Holographic sensors undergo interactions with various stimulants which can be chemical or biological species or a physical condition. The interaction causes variation of a physical property of the support medium and such variation causes a change in the optical characteristics of the holographic sensor which is remotely detectable.

The physical property of the support medium which changes may be its charge density, volume, shape, density, viscosity, strength, hardness, charge, hydrophobicity, swellability, integrity, cross-link density or any other physical property. Variation of the or each physical property, in turn, causes a variation of an optical characteristic such as polarisability, reflectance, refractance or absorbence of the hologram. Preferably, the change in optical characteristics of the hologram is a change in the wavelength which can be observed as a visible change in the colour.

Holographic sensors can be prepared by passing a single diverged laser beam through a specially designed analyte-responsive hydrogel coated on a transparent substrate (plastic or glass) backed by a mirror. Interference between the incident and reflected laser beams, followed by photographic development and fixing, creates holographic fringes lying in planes approximately parallel with the hydrogel surface. Under ordinary white light illumination, constructive interference between partial reflections from each fringe plane gives rise to a characteristic spectral peak with a wavelength governed by the Bragg equation.

Changes in the spacing of the fringes or the average refractive index will generate observable changes in the wavelength (colour) of the reflection hologram that are discernable by eye or spectrophotometrically. If the polymer matrix swells in response to interaction with a biological species, the spacing between the fringes increases, causing a longer wavelength of light to be reflected. Conversely, if the polymer matrix contracts in response to the interaction the light that is reflected shifts from longer to shorter wavelengths.

The biological indicator for use in the present invention also comprises a biological species which can be spores or an enzyme. Where spores are used, they are typically spores of a microorganism, such as a bacterium or a fungus which has a resistance to sterilisation which is several times higher than that of any microorganism that would be likely to be present due to natural contamination. Any suitable spores can be used in the present invention, for example those of Bacillus stearothermophilus or Bacillus subtilis. The spores may be incorporated into the holographic sensor in or on the support medium or may be on a spore disc which is remote from the sensor.

Where an enzyme is used, the activity of the enzyme should be correlated with the survival of a test microorganism. Suitable enzymes are known, for example, from US 2002/0115131. The enzyme should be disposed in or on the support medium of the holographic sensor.

The spores or enzyme can be incorporated into the sensor during manufacture, usually by suspending them in the support medium which is a hydrogel. The spores or enzyme can be washed and centrifuged into pellets before suspension. The ability of the spores or enzyme to resist harsh sterilants means that they are largely unaffected with the mild conditions associated with holographic sensor manufacture. When the spores or enzymes are embedded in the sensor, any physical changes result in a change in the interaction with the support medium leading to a high level of sensitivity.

In one embodiment of the invention, the holographic sensor is sensitive to the pH changes caused by spore growth. In this case, the holographic sensor may be remote from the spores which can be positioned on a spore disc.

Alternatively, the holographic sensor may be sensitive to physical changes caused by spore growth such as swelling or to metabolites produced by spore growth, for example glucose, calcium ions or DPA (dipicolinic acid).

The first step of the methods of the present invention is to contact the spores or enzyme with a sterilising agent. Any sterilising agent can be used in the present invention, including gases (such as steam or an antimicrobial gas) and liquid sterilants (such as liquid peracetic acid, active chlorine compounds, active iodine compounds, active bromine compounds, hydrogen peroxide, aldehydes or phenolic compounds).

Where the biological species in the indicator are spores, the spores are contacted with a growth medium which allows any surviving spores to grow. In this embodiment, the biological indicator includes a sealed vessel containing any conventional growth medium. After contact of the spores with sterilant, the vessel is compromised.

A change in optical properties of the sensor can be observed with the naked eye or, preferably, with an optical reader. An optical reader can be a spectrophotometer which has the ability to measure hundreds of spectral bands with a resolution of 1 nm. In contrast, the human eye relies on any three spectral bands, i.e. blue, green and red corresponding to the three visual pigments. A spectrophotometer can detect very small changes in the optical characteristics which gives a very sensitive result.

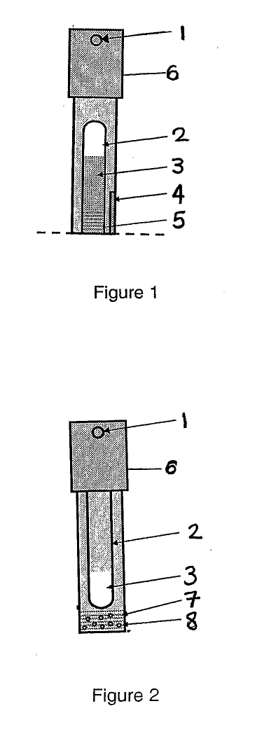

The present invention will now be described by way of example only with reference to the accompanying drawings. FIGS. 1 and 2 show biological indicators for use in different embodiments of the present invention.

FIG. 1 shows an embodiment where the holographic sensor 5 comprises a pH-sensitive support medium. Such support media are preferably hydrogels which are pH-sensitive as a result of one or more ionic or ionisable monomers in the polymeric backbone or the presence of cross-linkable units. The support medium contains reflection holograms in which the replay colour is dependent on the pH of the sample solution.

The sterilant can enter the biological indicator through a port 1 and contacts a spore disc 4. The biological indicator also comprises a vessel 2 containing growth medium 3 and a pH-sensitive holographic sensor 5. After sterilising agent enters the port 1 and contacts the spores 5, the lid 6 of the indicator is depressed, breaking the vessel and releasing the growth medium to contact the spores. Any surviving spores grow and result in a pH change. However, rather than a pH indicator dye as in conventional indicators, the pH-sensitive holographic sensor detects changes in the pH.

pH-sensitive holograms, unlike conventional pH indicators, are very flexible and can be selected to suit different pH ranges by selecting support medium having particular characteristics. For example, the hydrophobicity of the polymer backbone or pKa of the functional monomer may be designed to provide optimum results for any given spore.

As well as colour flexibility, another advantage of pH-sensitive holographic sensors is their extreme sensitivity to pH changes. A big wavelength shift can be achieved for a very small pH change which is much more dramatic than the wavelength changes in conventional pH indicators. In one example, a wavelength change of 500 nm is obtained for a 0.2 pH change.

When used in combination with an optical reader to detect the change in optical properties of the holographic sensor, very small pH changes relating to spore growth can be monitored. Inexpensive portable optical readers can be used which typically have a 1 nm wavelength resolution, permitting changes of less than 0.1 pH units to be detected.

The improved sensitivity of the present invention leads to significantly improved detection times.

The present invention also has the advantage that the hydrogel matrix can act as a pH buffer. Spore growth is accompanied by a decrease in pH as carbohydrates are metabolised. However, when the carbohydrate becomes scarce, the microorganisms may metabolise amino acids, leading to an increase in pH which can cause a conventional pH indicator to revert to the initial colour and hence give a false positive. To avoid this, in conventional biological indicators, reversion buffers are often added to make any colour change irreversible. In the present invention, the hydrogel may have inherent buffering capabilities, obviating the need for colour reversion buffers.

FIG. 2 shows a biological indicator for use in an embodiment of the present invention, wherein spores 8 are disposed in or on the vicinity of a holographic sensor 7. The biological indicator may contain a port 1 for entrance of a sterilant to the biological indicator, a lid 6, a vessel 2 and growth medium 3. As with conventional biological indicators such as those known, for example from US 2002/0115131, the indicator is impermeable to bacteria present in the environment.

After a sterilant has entered the port and contacted the spores 8, the lid is depressed to release the growth medium 3 which contacts the spores 8. Growth of the surviving spores then causes physical or chemical interactions in the sensor which causes a change in the optical characteristics.

In one embodiment of the invention, metabolite receptors are incorporated into the support medium which react with metabolites produced or consumed on growth of the spores. Locating the spores in or on the support medium means that any metabolites produced or consumed are concentrated in the support medium and interact immediately with the medium giving a very quick response time. This method has been found to produce rapid results, typically in under 3 hours.

Even without using metabolite-sensitive sensors, the physical changes associated with spore growth disrupt the medium, leading to observable changes in the sensor.

Where an enzyme is used, it is not necessary to have a growth medium, as the interaction between the enzyme and the support medium of the holographic sensor is determined by the activity in the enzyme which, in turn, is correlated with the survival of a test microorganism.

1. A method of determining the effectiveness of a sterilization procedure using a biological indicator, the biological indicator comprising a holographic sensor and spores, where the holographic sensor comprises a support medium having a hologram disposed therein or thereon, the method comprising the steps of:
a) contacting the spores with a sterilizing agent; then
b) contacting the spores with a growth medium and allowing any surviving spores to grow, wherein spore growth causes variation of a physical property of the support medium and that variation causes a change in the optical characteristics of the holographic sensor; and
c) observing an optical property of the holographic sensor, to detect changes resulting from spore growth.

2. The method according to claim 1, wherein a pH change resulting from spore growth causes the variation of a physical property of the support medium.

3. The method according to claim 1, wherein the spores are in or on the support medium.

4. The method according to claim 3, wherein a physical change in the spores caused by growth causes the variation of a physical property of the support medium.

5. The method according to claim 1, wherein a metabolite produced by spore growth interacts with the support medium and causes the variation of a physical property of the support medium.

6. The method according to claim 5, wherein the metabolite is calcium ions, glucose or DPA.

7. A method of determining the effectiveness of a sterilization procedure using a biological indicator, the biological indicator comprising a holographic sensor and an enzyme where the holographic sensor comprises a support medium having a hologram disposed therein or thereon,
where the activity of the enzyme is correlated with the survival of a test microorganism,
the activity of the enzyme determines the degree of interaction between the enzyme and the support medium, and
interaction of the enzyme with the support medium causes variation of a physical property of the support medium and that variation causes a change in the optical characteristics of the holographic sensor,
the method comprising the steps of:
a) contacting the enzyme with a sterilizing agent; and
b) observing an optical property of the holographic sensor to detect changes resulting from a change in the activity of the enzyme.

8. The method according to claim 7, wherein the support medium is a hydrogel matrix.

9. The method according to claim 8, wherein the hydrogel matrix is a pH buffer.

10. The method according to claim 7, wherein the holographic sensor is covered with a film that is impermeable to bacteria but permeable to the sterilizing agent.

11. The method according to claim 7, wherein the change in the optical characteristics of the holographic sensor is visible.

12. The method according to claim 7, wherein the observing is carried out using an optical reader.

13. A biological indicator comprising a holographic sensor which comprises a support medium having a hologram disposed therein or thereon and spores or an enzyme.

14. The method, according to claim 4, wherein the physical change caused by growth is swelling.

15. The method according to claim 1, wherein the support medium is a hydrogel matrix.

16. The method according to claim 15, wherein the hydrogel matrix is a pH buffer.

17. The method according to claim 1, wherein the holographic sensor is covered with a film that is impermeable to bacteria but permeable to the sterilizing agent.

18. The method according to claim 1, wherein the change in the optical characteristics of the holographic sensor is visible.

19. The method according to claim 1, wherein the observing is carried out using an optical reader.
